(19) United States
(12) Patent Application Publication
(10) Pub. No.: US 2014/0258087 A1
(43) Pub. Date: Sep. 11, 2014

(54) SYSTEM AND METHOD FOR FACILITATING WEB-BASED PEER-TO-PEER ROTATING FINANCIAL TRANSACTIONS

(71) Applicant: YATTOS, INC., San Francisco, CA (US)

(72) Inventors: Roberto BARGAGLI, San Francisco, CA (US); Eric Nunez, San Francisco, CA (US)

(73) Assignee: Yattos, Inc., San Francisco, CA (US)

(21) Appl. No.: 13/791,650

(22) Filed: Mar. 8, 2013

(51) Int. Cl. G06Q 40/02

(52) U.S. Cl. CPC G06Q 40/025
USPC 705/38

(57) ABSTRACT

Various methods and systems for facilitating web-based peer-to-peer rotating financial transactions associated with a rotating fund shared among a circle of peers connected within one or more social networks are disclosed. In embodiments, a web service platform executed by a funding system enables a first party to organize a funding circle. The parties participating in the funding circle are invited from at least one social network associated with the first party. The financial transactions associated with the funding circle are pre-approved with one or more electronic payment processing services. As such, the rotating funding system leverages the advantages of automated electronic payment services and social networking services to provide a seamlessly integrated platform for engaging in the peer-to-peer rotating financial transactions.

### FIELD

The present invention relates generally to peer-to-peer lending. More particularly, the present invention relates to a system and method for facilitating web-based peer-to-peer rotating financial transactions among participants connected within one or more trusted social networks.

### BACKGROUND

The rapid growth in Internet and digital technology has revolutionized the loan industry. Individuals seeking to fund their hobbies or small businesses have increasingly abandoned traditional financial institutions in favor of online peer-to-peer loan services (or simply, “P2P services”). Through the P2P services, individuals are able to obtain personal loans from other individuals (i.e., “peers”). Typically, these P2P services facilitate the personal loans by matching up individual “borrowers” in need of money with individual “lenders” who are willing to invest in the loans and lend the needed money. Unlike loans offered by traditional institutions, these personal loans do not require secured collateral, and lenders are willing to take such risk in exchange for repayments at certain interest rates. Although the personal loans offered by the P2P services provide a much welcomed alternative to traditional loans, many disadvantages still exist for both lenders and borrowers alike.

One disadvantage resides in the high interest rates inherent in the personal loans. Typically, the P2P services set the interest rates for these loans based on the credit worthiness of borrowers (e.g., verification of borrower identity, bank account, employment and income, credit checks, filtering of unqualified “bad credit” borrowers, etc.). As typical borrowers are those with bad (or non-existing) credit, the offered personal loans carry high interest rates in order to offset default risks. Borrowers often are forced to accept this high interest option in order to satisfy their urgent financial obligations, especially as the typical borrowers are those who have been rejected by traditional financial institutions.

Another disadvantage lies in the high default risk inherent in the personal loans. As the personal loans are unsecured, high delinquency rates are prevalent. Besides the high interest repayments, no other incentives exist to address the delinquency rates. As such, only few high risk taking lenders participate. Without a wide selection of lenders available, borrowers are forced to accept the few interest rate options offered. Further, a lack of social connections in the P2P services exacerbates these challenges. The personal loans are facilitated by matching unrelated individuals, and no consideration is given to prior social ties or personal relationships. Understandably, lenders are hesitant to invest the money, and high interest rates remain necessary to provide a sense of security for investment in mere strangers.

Additionally, the current infrastructure of the loan industry offers no adequate relief to address the time constraint of individual financial needs. In some instances, an individual has an urgent need to obtain money to address, for example, a medical emergency. In other instances, the individual has an anticipated need to obtain money at a specific time to address, for example, tuition due in three months. The loan option through the P2P services is not ideal due to the necessarily high interest rates inherent in unsecured, high-risk transactions among strangers. Resorting to traditional institution loans often involves a long waiting period for a loan to process. Borrowing through a credit card provides a quick solution, but often involves incurring high interest rate payments that result in debt accumulation and unfavorable credit history.

Therefore, a solution that addresses the problems of high interest rates, high default risks, and time constraints is desirable.

### SUMMARY

The present invention relates to a system and method for facilitating web-based peer-to-peer rotating financial transactions among a circle of participants connected within one or more trusted social networks. Various embodiments of the present invention enable a web-based peer-to-peer rotating funding circle to be implemented, where such circle allows each participating party to benefit from a rotating fund on a cycle-to-cycle basis. The peer-to-peer rotating financial transaction circle operates on a web service platform. The web service platform is seamlessly integrated with social networking services and electronic payment processing services, enabling financial transactions to take place effortlessly and automatically among trusted, reliable peers. Various embodiments of the present invention also enable a set of risk management tools to be provided so that the financial transactions may be managed and facilitated without the problems plaguing existing P2P services.

In some embodiments, a system and method for facilitating web-based peer-to-peer rotating financial transactions is disclosed. In one embodiment, a web-based peer-to-peer rotating funding system (or simply, “funding system”) is disclosed. The funding system comprises a web service platform integrated with a social networking interface and a payment processing service interface. In one embodiment, a method for organizing a peer-to-peer rotating funding circle (or simply, “funding circle”) using the web service platform is disclosed. In one embodiment, a method for accepting an invitation to an organized funding circle is disclosed. In one embodiment, a method for generating a dynamic display associated with the funding circle is disclosed. In one embodiment, a method for determining a rotating funding cycle (or simply, a “rotating cycle”) for use by the funding system in facilitating the funding circle is disclosed.

In some embodiments, a system and method for managing default risk associated with the web-based peer-to-peer rotating financial transactions is disclosed. In one embodiment, a risk management system is disclosed. The risk management system provides a set of risk management tools for addressing late contribution payments by participating parties of the funding circle. In some instances, social pressure is applied to address default risk (e.g. web service platform transparency, Circle score, reminder messages). In other instances, concrete resolution options are provided to the organizer (and the parties) for taking certain actions in regards to any default risk associated with the funding circle (e.g. shift cycle, suspend, cancel, restart, etc.).

Some embodiments of the invention have other aspects, elements, features, and steps in addition to or in place of what is described above. These potential additions and replacements are described throughout the rest of the specification.

### BRIEF DESCRIPTION OF THE DRAWINGS

Embodiments of the present invention are described and explained by way of example and not limitation through the use of the accompanying drawings:

FIG. 1 is a block diagram of a network based environment where one or more embodiments of the present invention may be implemented;

FIG. 2 illustrates an example system architecture of a web-based peer-to-peer rotating funding system 200 (or simply, a “funding system”) with which one or more embodiments of the present invention may be utilized.

FIG. 3 is a flow diagram illustrating a method for providing access to a web service platform in accordance with an embodiment of the present invention;

FIG. 4 is a flow diagram illustrating a method for enabling organization of a funding circle in accordance with an embodiment of the present invention;

FIG. 5 is a flow diagram illustrating a method for enabling joining an organized funding circle via an invitation in accordance with an embodiment of the present invention;

FIG. 6 provides an example illustrating rotating funding cycles with fractional parameters and corresponding sets of values computed for a funding circle of ten parties in accordance with an embodiment of the present invention;

FIG. 7 is a block diagram illustrating the functionalities offered by the funding system via the web service platform in accordance with an embodiment of the present invention;

FIG. 8 is an example of dynamic content generated according to a position selected by a party in accordance with an embodiment of the present invention;

FIG. 9 is an example position details link generated according to a selection of a position in accordance with an embodiment of the present invention; and

FIG. 10 is a flow diagram illustrating a method for addressing a late contribution payment in accordance with an embodiment of the present invention.

The figures depict various embodiments of the present invention for purposes of illustration only. One skilled in the art will readily recognize from the following discussion that alternative embodiments of the systems and methods illustrated herein may be employed without departing from the principles of the invention described herein.

### DETAILED DESCRIPTION

Various embodiments of the present invention relate to a system and method for facilitating web-based peer-to-peer rotating financial transactions among a circle of participants connected within one or more social networks. Traditionally, existing P2P services have facilitated loan transactions by connecting unrelated, and often unreliable, strangers to provide borrowers a relatively quick option (i.e., as compared to traditional financial institutions) to obtain loans. The personal loans through these P2P services, however, carry high interest repayment obligations due to the high default risks and qualification hurdles inherent in credit-based model utilized by the P2P services.

In contrast, various embodiments of the present invention allow for a financial transaction model based on social connections, where trusted, reliable peers make web-based peer-to-peer rotating financial transactions toward a rotating fund (e.g., loan amount) that benefits every participating party on a cycle basis. Additionally, the financial transactions are made seamlessly through interfacing with electronic payment processing services, allowing transactions to be automated and hassle-free.

In embodiments, the financial transaction model involves a peer-to-peer funding circle where parties, connected within one or more social networks, make fractional contribution payments, on a rotating cycle-to-cycle basis, toward a fund amount solicited by an organizer of the funding circle (or simply, a “first party”). The first party receives the solicited fund amount in one cycle, and each of the remaining participating parties gets to receive the same fund amount at a different time on a cycle-to-cycle basis. In particular, at each cycle, the “lender” party plays the role of a “contributing party” contributing a small, fractional payment while the “borrower” party plays the role of a “receiving party” receiving the fund amount. As a result of the cycling rotations, every “lender” becomes a “borrower,” where every party in the funding circle gets to benefit from the large fund amount contributed by all participating parties. In exchange for facilitation of the financial transactions, a low platform fee is extracted from each transaction, enabling each participating party to receive the needed money with a low “interest rate.” Additionally, in embodiments, the financial transaction model involves implementation of risk management tools that deliver benefits unprecedented in existing P2P services.

Implementations of the financial transaction model provide many advantages including: providing a low-risk financial collaboration based on trusted social connections; enhancing the return on investment by allowing every lender to become a borrower; offering a personal loan option with a low “interest rate” in the form of a platform fee; and enabling a savings plan option for individuals to transform their small amounts of surplus savings into a large, collaborative amount that could fund a major expense.

While, for convenience, embodiments of the present invention are described with reference to loan transactions, embodiments of the present invention are equally applicable to various other applications where electronically processed financial transactions rotated among socially connected peers are utilized. For example, embodiments of the financial model may be utilized to rotate, or shift, possession of a product among connected peers on a rotating cycle-to-cycle basis. In the example, the product is being purchased by the large, collaborative amount funded by fractional payments of all participating parties. In such instances, the organizing peer (i.e., the first party) takes the role of the receiving party holding possession of the product in the first cycle, for example, while the remaining peers are the contributing parties making payments to the product's seller.

The techniques introduced herein may be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

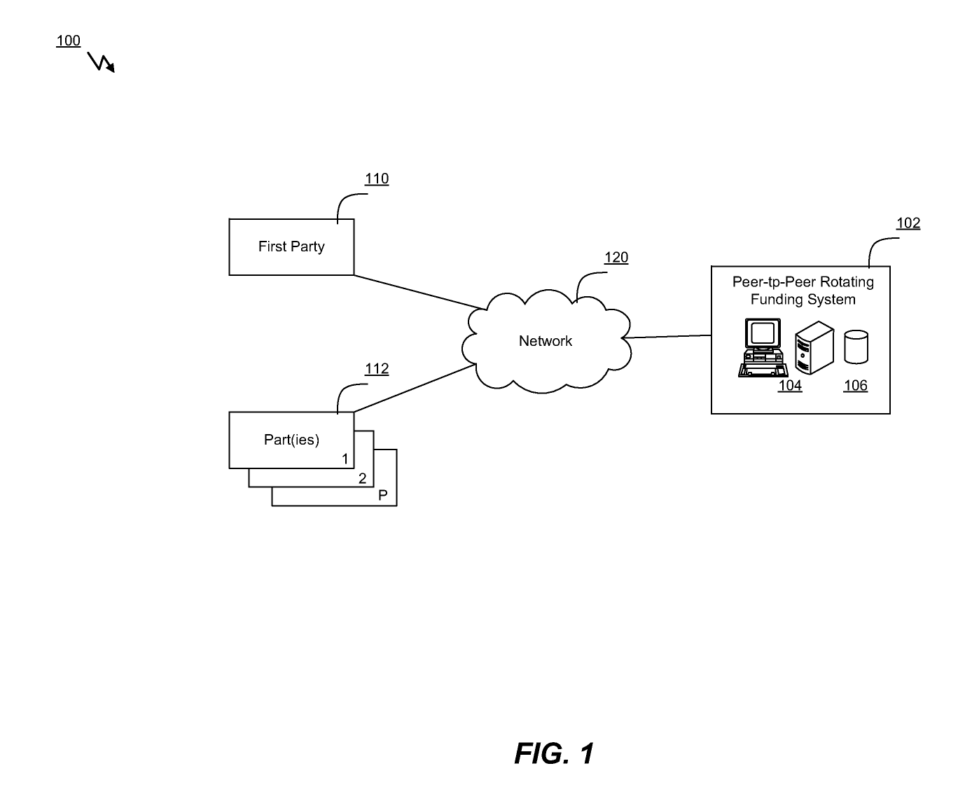

Accordingly, various embodiments of the present invention will be discussed in detail below with the aid of FIGS. 1-10. References in this specification to “an embodiment,” “one embodiment,” or the like, mean that the particular feature, structure, or characteristic being described is included in at least one embodiment of the present invention. Occurrences of such phrases do not all necessarily refer to the same embodiment, nor are they necessarily mutually exclusive. Similarly, terminology used below is to be interpreted in its broadest reasonable manner, even though it is being used in conjunction with a detailed description of certain specific examples of the invention. Although certain terms may be emphasized below, any terminology intended to be interpreted in any restricted manner will be overtly and specifically defined as such in this Detailed Description section.

Although not required, aspects of the present invention may be described below in the general context of computer-executable instructions. One skilled in the art will appreciate that other computer system configurations and communication schemes may be used for implementing the system and method introduced herein, including: wireless devices, Internet appliances, hand-held devices (including personal digital assistances (PDAs)), wearable computers, all manner of cellular or mobile phones, multi-processor systems, microprocessor-based or programmable consumer electronics, mini-computers, network PCs, mainframe computers, and the like. Indeed, the terms “computer,” “server,” “module,” and the like are used interchangeably herein, and may refer to any of the above devices and systems.

While aspects of the present invention, such as certain functions, are described as being performed exclusively on a single system, the present invention may also be practiced in distributed environments where functions or modules are shared among disparate processing systems. The disparate processing devices are linked through a communications network, such as a Local Area Network (LAN), Wide Area Network (WAN), or the Internet. In a distributed computing environment, program modules may be located in both local and removable memory storage devices.

FIG. 1 illustrates a network diagram of a suitable environment 100 in which various embodiments of the present invention may be implemented. However, various modifications to the environment 100, such as an inclusion of additional devices, consolidation and/or deletion of various devices, and the shifting of functionality from one device to another, may be made without deviating from the present invention. Referring to FIG. 1, the environment 100 includes a web-based peer-to-peer rotating funding system 102 (or simply, a “funding system”) in communication with a first party 110 and a plurality of P parties 112 through a network 120. As will be discussed in further detail below, the funding system 102 includes a server computer system 104 coupled to a database 106, such as a local database and/or a remote database.

The first party 110 and the plurality of P parties 112 individually connects to the funding system 102 via the network 120 using a computing device, such as a personal computer, a mobile device, etc. The term “personal computer,” as used herein, may be a desktop computer, a multiprocessor system, a microprocessor-based or programmable consumer electronic device, a television, a digital video recorder, a media center device, a set-top box, other interactive television device, and/or the likes. The term “mobile device,” as used herein, may be a cellular phone, a personal digital assistant (PDA), a portable email device (e.g., a Blackberry®), a portable media player (e.g., an IPod Touch®), or any other device having communication capability to connect to the network 120.

The network 120 may be a local area network (LAN), a wide area network (WAN) (e.g., the Internet), or wireless networks. Additionally, the network 120 may be any type of cellular, IP-based or converged telecommunications network, including but not limited to Global System for Mobile Communications (GSM), Time Division Multiple Access (TDMA), Code Division Multiple Access (CDMA), Enhanced Data GSM Environment (EDGE), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

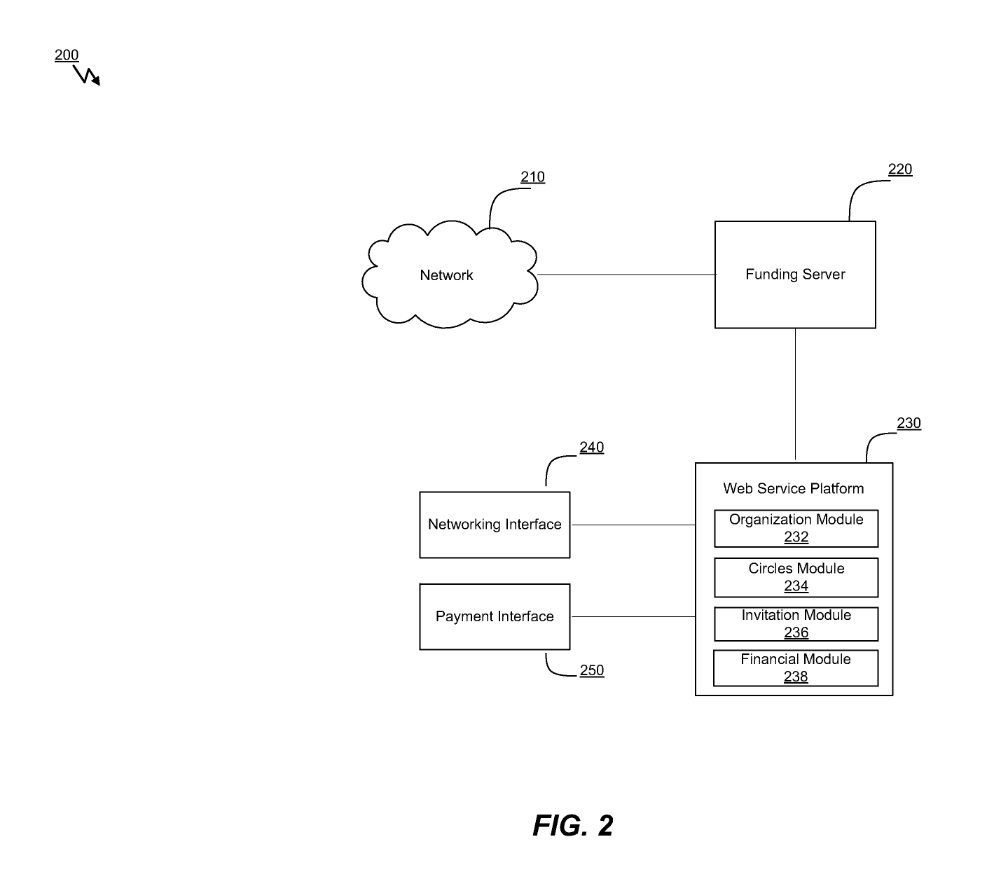

FIG. 2 illustrates an example system architecture of a web-based peer-to-peer rotating funding system 200 (or simply, a “funding system”) with which one or more embodiments of the present invention may be utilized. The funding system 200 may be the funding system 102 of FIG. 1. Components that are not germane to the purpose of the discussion are not shown in the illustration. In other embodiments, the funding system 200 may include additional, fewer, or different components for various applications. In the present illustration, the funding system 200 includes a network 210, a server computer system 220 (or simply, “funding server”), a web service platform 230, a social networking interface 240 (or simply, a “networking interface”), and a payment processing service interface 250 (or simply, a “payment interface”). The network 210 may be the network 120 of FIG. 1.

The funding server 220 may be any computing device capable of communication with the network 210 to provide content to users of the funding system 200. The funding server 220 may also be configured to manage financial transactions associated with the funding system 200. Devices that may operate as the funding server 220 include, but are not limited to, personal computers, multi-processor systems, microprocessor-based or programmable consumer electronic devices, servers, and/or the likes. The funding server 220 may be a single computing device. The functionality of the funding server 220 may be distributed across multiple computing devices or may be integrated into another device.

The web service platform 230 may be any computing device capable of communicating over a network. The web service platform 230 may be utilized by the funding server 220 to deliver content to the users (e.g., party 112) of the funding system 200 and/or to interact with the users following responses to the delivered content over the network 210. As will be discussed in further detail below, a plurality of functionalities of the funding system 200 are offered to the users via the web service platform 230. The functionalities are executed on the web service platform 230 by different modules. As shown, the web service platform 230 includes an organization module 232, a circles module 324, an invitation module 236, and a financial module 238. The modules are executable on a programmed data processor of the funding server 122.

The organization module 232 may be used to enable an organization of a rotating peer-to-peer funding circle (or simply, “funding circle”) on the web service platform 230. The circles module 234 may be used to enable viewing, monitoring, and managing of all activities associated with the funding circle (e.g., an organized funding circle and/or active funding circle) on the web service platform 230. The invitation module 236 may be used to enable viewing, monitoring, and managing of an invitation associated with an organized funding circle. The financial module 238 may be used to enable storing, processing, and computing of all financial variables associated with a funding circle. The financial module 238 may be used, for example, to generate a rotating funding cycle and associated financial variables for use by the funding system 200 to facilitate the financial transactions of the funding circle. The financial variables may include, for example, terms of the funding circle, a fund receiving amount, a cycle contribution amount, a platform fee, and a fixed fractional contribution.

The web service platform 230 may be configured to connect with a plurality of third party social networking services (e.g. Facebook®, LinkedIn®, Google®+, etc.) via the social networking interface 240 (or simply, “networking interface”). Additionally, the web service platform 230 may be configured to connect with a plurality of third party payment processing services (e.g. PayPal®, VISA®, etc.) via the payment processing interface 250 (or simply, “payment interface”). As will be discussed further in detail below, the integrated communication between the web service platform 230, the networking interface 240, and the payment interface 250 enables the funding system 200 to provide automated, trusted reliable financial transactions for the users of the system.

Integrated communication between the web service platform 230, the networking interface 240, and the payment interface 250 ensures a seamless user experience. When integrated, a user is not required to switch manually between various applications (e.g., Facebook®, PayPal®, and web service platform 230) in order to utilize the functionalities offered by the funding system 200. A seamless integrated communication is important to the funding system 200 for several reasons. First, customized user data about a party's identity is readily available and contained in one or more social networks in which the party belongs. For example, when a user (e.g., a first party) wants to start accessing the web service platform, integration with the social networking service associated with the user allows the funding system to extract efficiently the data needed to create that user's profile on the web service platform. Second, the customized user data contains valuable social networking information that allows the funding system conveniently to map out the party's social circles of friends and family members, such that the party is able to reach out for financial support with ease. Lastly, having an integrated payment processing service allows financial transactions executed on the web service platform to flow effortlessly (e.g., pre-approved automated transactions). Further details will be discussed below in various embodiments of the present invention to illustrate the importance of the seamless integration.

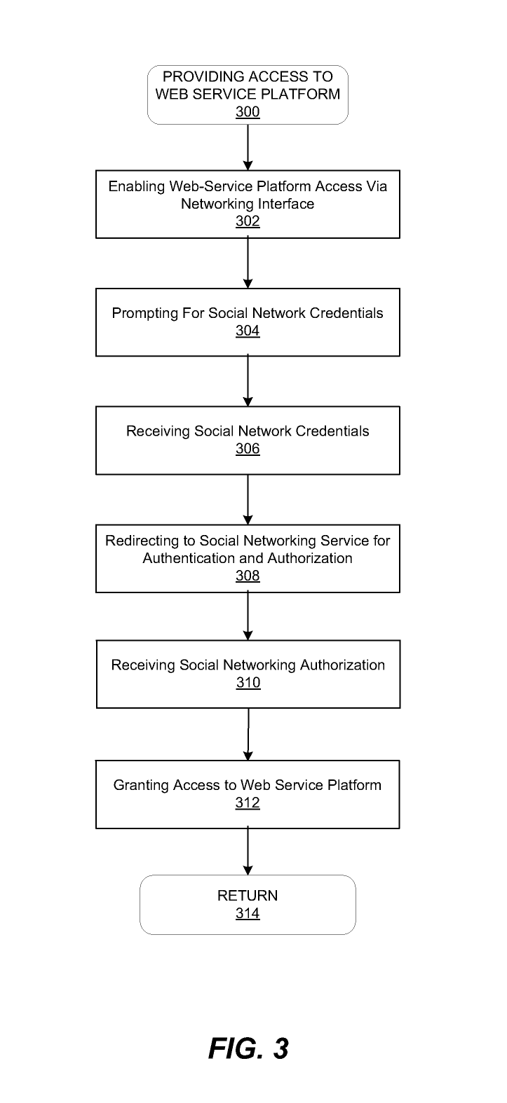

FIG. 3 is a flow diagram illustrating a method 300 for providing access to the web service platform using the networking interface in accordance with an embodiment of the present invention. The illustrated method incorporates social connections into the organization of a funding circle. Incorporation of social connections provides unprecedented benefits and addresses the problems of traditional P2P systems. Social connections help foster a trusting, reliable environment for low-risk financial transactions between peers. For example, when the first party is a close friend or family member who has a medical emergency, participating parties will be more likely to understand the financial urgency and are less likely to default (i.e., quit contributing to the first party's personal cause). Unlike the prior arts, return on investment does not operate as the sole incentive in lending transactions involving personal relationships. The trust built on these social relationships help diminish the problems of high default risks and the accompanying high interest rates present in the prior art. The choice to commit in the lending process is based on the first party's personal attributes and social credibility, not credit worthiness. Additionally, the social pressure of shame among connected peers, unlike unrelated strangers, operates as a risk management tool, as people are less likely to default to members of their own social communities.

In embodiments, using the web service platform integrated with the networking interface, an organizer of a funding circle (i.e., a first party) may connect to one or more social networks in which he/she belongs. The term “social network” as used herein may be a web-based community (e.g., Facebook®, LinkedIn®, Orkut®, Google+®, Yahoo®, Pinterest®, Twitter®, etc.), an email-network community (e.g., Gmail®, Yahoo! Mail®, etc.), an instant messaging community (e.g., Google Talk®, AIM®, MSN Messenger®, IMO®, etc.), or any other social communities capable of maintaining data associated with social connections between individuals and their peers. Such integrated connection with the social networks allows the first party to connect effortlessly with friends and family to organize the funding circle, invite a plurality of parties from the social networks to participate, and establish effective communications regarding activities associated with the funding circle (e.g., reminder on a delayed contribution payment, celebratory announcement about a completed funding circle, etc.). For example, the first party can utilize email to connect to his/her email contacts and send invitations to join the first party's funding circle effortlessly using the integrated web service platform.

Referring to FIG. 3, at step 302, the web service platform is provided for the first party to start organizing a funding circle. At step 304, the funding system enables the first party to gain access to the web service platform by prompting for login credentials associated with a social network. The first party is required to select at least one social network for submitting the login credentials. In an illustrative example, the first party navigates to an Internet web page containing the web service platform, where the first party is presented a plurality of social networks from which to select (and to submit credentials) in order to access the web service platform. At step 306, the first party's submission of the login credentials associated with at least one social network is accepted.

At step 308, the first party is redirected, via the networking interface, to a third party social networking service (or simply, “networking service”) associated with the selected social network for credentials authentication. The authentication may be by any protocol utilized by the networking service (e.g., OAuth). Upon successful authentication, the party is prompted by the networking service to authorize communications with the web service platform. Authorization enables data exchange between the funding system and the social networking service. The authorization may be by any protocol utilized by the networking service. Authentication and authorization allow the funding system to obtain identity information and social connections information from the one or more social networks associated with the first party.

At step 310, the first party's authorization to exchange data is received from the networking service. In embodiments, authorization is required for the first party to proceed in gaining access to the web service platform. As discussed above, authorization allows seamless exchange of data between the funding system and the networking system. Without authorization, the web service platform is not able to proceed in providing its functionalities to the first party.

In embodiments, authentication and authorization may be repeated for each of the social networks selected by the first party. Multiple social network connections allow the web service platform to perform various tasks across a wide selection of social networks. For example, the first party may choose to repeat the process three times to reach out to three different social networks. In such example, the web service platform is able to perform many tasks across the three networks. One task, for example, is populating a list of potential participating parties to be invited to the funding circle by extracting social contacts from all three social networks. Another task, for example, is making announcements related to the funding circle across all three social networks (e.g., post a message on a Facebook® wall, send an email to Gmail® contacts, and make an announcement on LinkedIn®). In some instances, the first party may choose to connect with additional social networks all at the same time, where steps 304-310 are repeated for each selected social network. In other instances, the first party may choose to connect with the additional social networks at a later time (e.g., after gaining access to the web service platform). It is noted that the specific order of when the first party connects to the additional social networks is not critical or essential to the operation of the methodologies discussed herein.

At step 312, the first party is redirected back to the web service platform, and access to the web service platform is granted to the first party. In embodiments, upon successful access to the web service platform, a user of the funding system (e.g., the first party or the plurality of P parties) is presented with a plurality of options for utilizing the web service platform, including, but is not limited to: organize a funding circle, view an invitation (i.e., an invitation to participate in a funding circle organized by another party), and view an active funding circle in which the user is an active participant (i.e., an active funding circle organized either by the first party or by another party). At step 314, the method 300 ends.

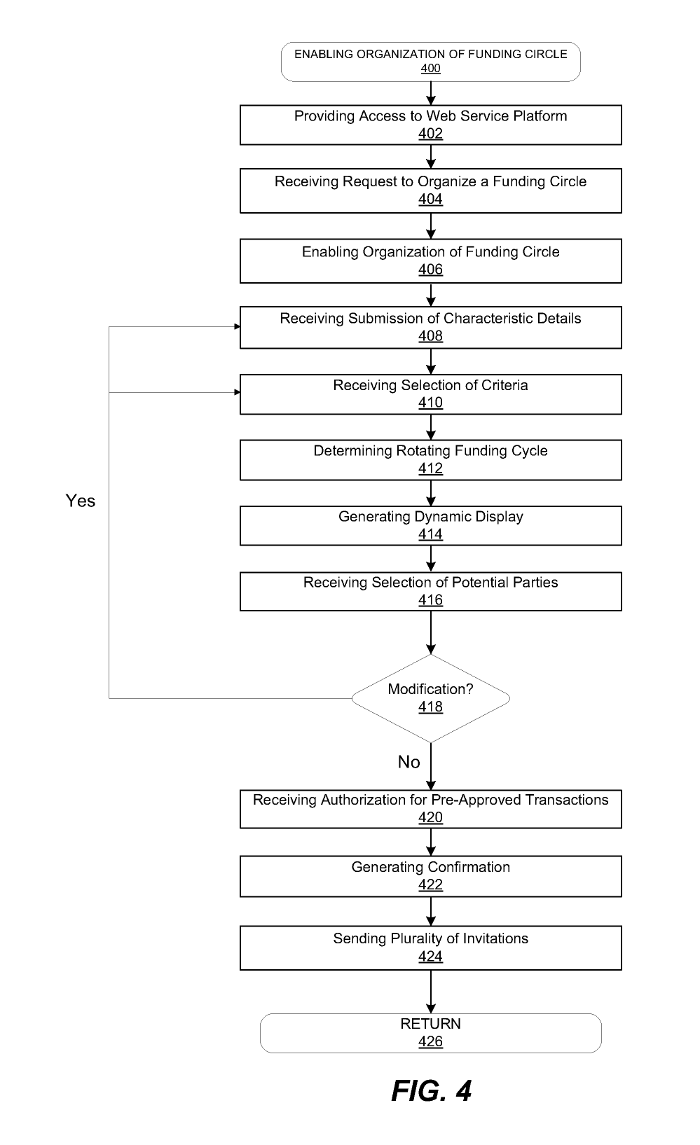

FIG. 4 is a flow diagram illustrating a method 400 for enabling the organization of a funding circle in accordance with one or more embodiments of the present invention. In embodiments, the method 300 of FIG. 3 may be utilized along with the method 400 of FIG. 4. Referring to FIG. 4, at step 402, the first party may start organizing a funding circle according to method 400 upon being provided access to the web service platform. Access to the web service platform may be obtained using the method 300 of FIG. 3. At the completion of step 402, it is presumed the first party has completed login authentication and authorization and has been granted access to the web service platform (as illustrated in FIG. 3). In step 404, the funding system receives a request from the first party to organize a funding circle.

At step 406, the first party's request is received, and the funding system enables the first party to start organizing. In the embodiment, the organization module generates a user interface (e.g., graphical user interface (GUI) for the party to start organizing the funding circle. At step 408, the first party starts organizing by submitting characteristic details about the personal cause for which the first party is seeking financial support. For example, the first party may submit a name or title for the personal cause (e.g. Boston Marathon, Emergency Operation, etc.) and a description to explain the personal cause. In such instances, the first party may choose to upload a content item (e.g., a photograph, a video, or a website link)) to enhance the first party's story, such that the solicited family and friends would be able to fully understand and connect with the first party's personal cause.

At step 410, the first party is allowed to select a plurality of criteria from a predetermined set of values generated by the funding system. The plurality of criteria presented to the first party includes, but is not limited to, a “home location”, a “frequency,” a “plurality of P parties,” a “fund amount,” and a “position.” Using the first party's selection of criteria, the funding system determines various aspects of the funding circle to be set up. Selection of a home location sets the currency for the financial transactions associated with the funding circle (e.g., a selection of a “United States” value sets the U.S. dollar as the currency). Selection of a frequency sets the number of predefined time periods at which financial transactions occur in the funding circle (e.g., a selection of a “monthly” value sets up a monthly payment schedule to occur for a total of five months for a five-party funding circle). Selection of a P value for the plurality of P parties sets the total number of participants in the funding circle (e.g., a selection of a P value of “5” sets up a five-party funding circle). Selection of a fund amount sets the loan amount for which the first party is soliciting. Selection of a position sets the time period, or cycle, at which the first party receives the solicited fund amount (e.g., a selection of “1” sets the first cycle to be the time at which the first party receives the fund amount).

In embodiments, the predetermined set of values for each of the criteria contain, but is not limited to, the following: the “home location” criterion includes predetermined countries (e.g. United States, Canada, United Kingdom, etc.); the “frequency” criterion includes predetermined periods (e.g. monthly, bimonthly, etc.); the “plurality of P parties” criterion includes predetermined integers (e.g. 5, 10, etc.); the “fund amount” criterion includes predetermined amounts (e.g., 900, 1800, 2700, 3600, 4500, or other amount); and the “position” criterion includes predetermined options corresponding to the P value selected for the plurality of P parties (e.g. positions 1-5 are generated in response to a selection of a P value of “5” for a five-party funding circle).

In embodiments, the plurality of criteria presented to the first party additionally includes a “charitable cause” criterion. The term “charitable cause” as defined herein includes any person, for-profit company, or non-profit organization, or any combinations thereof, which carries out one or more specific causes, such as a charitable service or activity, and receives the benefits of financial payments. A charitable cause may be, for example, a for-profit corporation that receives tax exempt status. The first party's selected charitable cause gets to receive a donation in an amount set at a certain percentage of the platform fee charged on the fund amount received. In embodiments, the final donation amount at the end of all cycles of a funding circle is the accumulation of individual percentage platform fees deducted at each cycle. For example, for every cycle, the funding system sets a 10% rate to deduct from the platform fee. That 10% amount gets contributed to the first party's selected charitable cause.

At step 412, the funding system determines for the funding circle a rotating funding cycle. As will be discussed in further detail herein, the financial transactions of the funding circle are facilitated by utilizing a rotating funding cycle (simply, “rotating cycle”) determined by the plurality of criteria selected by the first party (i.e., organizer). The financial transactions scheduled by the rotating cycle provides an advantage of allowing a “contributing party” to become a “receiving party.” The term “contributing party” as defined herein includes any participating party of the funding circle who makes financial contribution payments toward the fund amount set by the first party, similar to a “lender” of a loan. The term “receiving party” as defined herein includes any participating party of the funding circle who receives the fund amount, similar to a “borrower” of a loan. Thus, in the financial transaction model of the present invention, the original “borrower” (first party) is able to give back to friends and family for the financial support by becoming a contributing party, while the “lender” parties are able to take turn, on a rotating cycle basis, to be a borrower to receive the fund amount.

The rotating cycle contains a set of fractional parameters with a set of values computed according to the certain criteria selected. The set of fractional parameters includes terms and additional details associated with the funding circle. The rotating cycle operates by having each contributing party make a fixed fractional contribution amount on a rotating cycle basis. Accumulation of the individual fixed fractional contribution amounts in each cycle adds up to the solicited fund amount. The receiving party (i.e., non-contributing party) of each cycle receives the fund amount contributed by the contributing parties (i.e., the remaining participating parties). The solicited fund amount is the “fund amount” value selected by the first party when organizing the funding circle. The financial transactions involving the contributing and the receiving, continue on several rotating cycles until all participating parties have each received the rotating fund amount. The total number of rotating cycles is determined by the P value of the “plurality of P parties” criterion selected by the first party (e.g., five cycles exist for a selected P value of “5” signifying a five-party funding circle).

Whether a party is a receiving party or a contributing party in each cycle depends on the “position” selected by that party. For example, the first party selects a P value of “5” to have a funding circle created for five parties, where the total number of five rotating cycles exists for that funding circle. For each cycle of the five rotating cycles, four parties are the contributing parties who make the fixed fractional contribution payments toward the solicited fund amount, and the fifth party is the receiving party of the loan amount. In the first cycle, the first party, who has selected position “1,” gets to be the receiving party to receive the fund amount. In the second cycle, another different party, who may have selected position “2,” becomes the receiving party, and so on and so forth. After a total of five rotating cycles, each party in the circle will have received the fund amount, and each party will have made a total of four fixed fractional contribution payments.

In embodiments, the fixed fractional contribution amount a party has to make in each cycle is determined by the party's selected position in the funding circle. As such, the party's aggregated fractional contribution payments over a completed set of cycles (simply, “total contribution amount”) may differ based on the position selected. A lower position (i.e., a position that must wait at least one cycle to receive the loan amount), is compensated by an accompanying lower fixed fractional contribution amount. On the other hand, a higher position is accompanied by a higher fixed fractional contribution amount, but is compensated by a lesser waiting period for receiving the fund amount. For example, a first party, urgently in need of money, chooses a high position (e.g., position 1) to receive the fund amount without having to wait for a cycle to pass, if at all (e.g., cycle 1). In exchange, the first party's fixed fractional contribution amount to be paid at each subsequent cycle (e.g., cycle 2, cycle 3, cycle 4, and cycle 5) is higher as compared to the amount he would have had choosing a lower position, resulting in a higher total contribution amount.

As will be discussed in further detail herein, the present invention's utilization of the “position” criterion provides the advantage of enabling participating parties both to obtain a loan and to set up a savings plan. The resulting difference between the total contribution amount made and the fund amount received operates as out-of-pocket costs and/or return on investment. Parties who urgently need the money may choose to participate in exchange for a low “interest rate.” Parties who do not need the money right away may choose to participate to “save up” small bits of monetary surplus in exchange for a higher gain in return on investment at a later time. In example, a resulting excess loss (i.e. a negative difference between the total contribution amount and the loan amount) is equivalent to an interest rate loan payment (and any accompanying service fee) present in existing P2P services. Advantageously, however, the excess loss operates as affordable out-of-pocket costs for the participating party. The ratio of the excess amount paid over the fund amount received presents a very low percentage of cost for the “loan” facilitated. On the other hand, a resulting excess gain (i.e., a positive difference between the total contribution amount and the loan amount) operates as a return on investment for the parties who choose to delay receiving the fund amount.

In embodiments, the funding system, via the financial module, computes for each rotating cycle a set of values for a set of fractional parameters based on the plurality of criteria selected by the first party. A funding circle has a plurality of sets of fractional parameters, as each rotating cycle in the funding circle has a different set of fractional parameters. The values in each set of fractional parameters correspond to the various positions held by the parties participating in the funding circle. For example, the values of the fractional parameters for a party holding position “1” differ from those for the party holding position “2.” The term “values” as defined herein may be numerical values or text-based values (e.g., date of Feb. 26, 2013). In embodiments, each set of fractional parameters includes, but is not limited to, corresponding terms of the funding circle, a fund receiving date, a fund receiving amount, a cycle contribution date, and a cycle contribution amount. On each rotating cycle, the plurality of P parties participate in the funding circle (e.g. contribute or receive) according to the determined values in the set of fractional parameters.

In embodiments, the corresponding terms of the fractional parameters include, but is not limited to, a total quantity of contribution payments, a total contribution amount, a platform fee, an extra contribution amount, a first cycle contribution date, and a position details link associated with a particular party's selected position. The term “total quantity of contribution payments” as defined herein presents the numerical total of fixed contribution payments made by a particular party (e.g. a total quantity of 4 for a party in a five-party funding circle). The term “total contribution amount” as defined herein is the particular party's aggregated fractional contribution payments made over a completed set of cycles (e.g., the total four payments made over five cycles in a five-party funding circle). The term “platform fee” as defined herein is the service fee for each financial transaction charged by the funding system. The term “extra contribution amount” as defined herein is the difference (e.g., excess gain or excess loss) between the total contribution amount paid and the fund amount received. The term “first cycle contribution date” as defined herein is the date on which the first payment must be made by the particular party. The term “position details link” as defined herein is a link that generates additional information associated with the particular party's selected position. In some embodiments, the corresponding terms may include additional information associated with a particular party.

In embodiments, the term “fund receiving amount” as defined herein is the amount set by the first party's selection of “fund amount” criterion. The term “fund receiving date” as discussed herein is the date a particular party is to receive the fund amount. The term “fund receiving amount” as discussed herein remains the same for every participating party in the funding circle while the fund receiving date differs by cycle (e.g. a party in position 1 has an earlier fund receiving date than a party in position 2). The term “cycle contribution amount” as defined herein is the fixed contribution amount associated with a particular party, where the amount has to be paid on the cycle contribution date. As discussed, a party's higher cycle contribution amount (i.e., the fixed contribution amount), as compared to another party's cycle contribution amount, is compensated by a sooner fund receiving date.

At step 414, a dynamic display is generated, according to one embodiment, for the first party while making a position selection. The dynamic display contains the set of fractional parameters, such that the content of the display changes according to the first party's selection of the position. For example, a selected position “1” generates content containing fractional parameters corresponding to position 1 while a selected position “2” generates content containing fractional parameters corresponding to position 2. The fractional parameters computed for each particular position assists the first party in making an informed decision for selecting the appropriate position that corresponds to the first party's financial needs. For example, the dynamic display with the fractional parameters allows the first party to see that selecting a higher position will result in receiving the fund amount sooner while a lower position will yield a higher return on investment.

At step 416, a selection of a plurality of potential parties is received from the first party. In embodiments, the list of potential parties is generated by extracting individual profiles from one or more social networking services corresponding to the social networks associated with the first party. Connection with the social networking services is authenticated and authorized via the networking interface. For example, the first party may be connected to friends and family from three social networks by completing the authentication and authorization corresponding to each social network. As a result, the first party may have a mixed list of potential parties from a variety of social circles. In embodiments, the plurality of parties selected by the first party may be more than the plurality of P parties selected by the first party. For example, the first party selects a P value of 5, but may select 10 potential parties to join the five-party funding circle. As will be discussed further in the Detailed Description, the parties participating in the funding circle are determined by the potential parties who timely accept the first party's invitation to join. In embodiments, the first party may choose to change any selection for organizing the funding circle including the characteristic details, the plurality of criteria, and the potential parties.

At step 418, the funding system generates a summary for the first party to review, with an option for modification. At step 418, the funding system determines whether the party requests to modify information associated with the funding circle. The information may include, for example, the characteristic details and the criteria selected. In one example, if the funding system determines that the party requests to change the characteristic details, the system redirects the party to the GUI page to resubmit the characteristic details. In this example, the funding system may proceed to step 420 or may go through steps 410-418 again. In another example, if the funding system determines that the party requests to change the criteria selected, the system redirects the party to the GUI page to reselect the criteria in step 410. In this example, steps 412-418 are repeated as modification of the criteria affects many important functionalities (e.g., funding cycle) in the organization process. Once the funding system determines that no modification is requested (e.g., “No”), the first party is prompted to proceed with payment by connecting to at least one payment processing service.

As discussed above, the funding system is an integrated system, where the web service platform is integrated with the networking interface and the payment interface. Integration with the payment interface enables participating parties (including the first party) to connect to a plurality of payment processing services such that financial transactions may flow seamlessly between the parties. As used herein, the term “payment processing service” refers to all forms of electronic fund transfer services including, but is not limited to, online money transfer services (e.g., PayPal, etc.), credit cards (e.g., VISA, MasterCard, Discover, etc.), debit cards (e.g., a Cirrus card, a Plus card, a Maestro card, an Interlink card, etc.), etc. The term “card” (e.g. credit cards, debit cards, etc.) also contemplates a private label card issued or maintained by an organization and a prepaid card that can be purchased by cash, check, credit, or debit cards. As will be discussed further in detail below, the payment processing service operates as an “e-wallet” of a party for handling financial transactions associated with the funding circle. With seamless integration between the funding system and the payment processing service(s), the financial transactions are automatically debited and credited via the e-wallet.

At step 420, the first party is prompted, via the payment interface, for login credentials to at least one payment processing service. In some instances, where the first party does not belong to any payment processing service, the first party is requested to setup an electronic payment account, typically known as an “e-wallet” account, with a payment processing system. The payment processing service may be third party entities recommended by the funding system to the first party. In other instances, where the first party does have an existing e-wallet account, the first party is prompted to submit login credentials via the payment interface. Upon successful authentication (or successful e-wallet setup) with the payment processing service, the first party proceeds by authorizing pre-approved financial transactions associated with the funding circle. Authorization allows the funding system to automatically receive scheduled pre-approved transactions associated with the first party's activities in the funding circle. The scheduled pre-approved transactions, for example, may be payments, on a rotating basis, toward the fund amount received by the rotating “borrowing” party in the funding circle. In the illustrated process of FIG. 3, authentication and authorization allows financial transactions to take place automatically on behalf of the first party according to the rotating cycle, without any manual processing or interruption. By the end of step 316, authorization is received and the funding system allows the first party to proceed with organization of the funding circle. At step 422, a summary is generated for the first party to review the details of the organized funding circle. In other embodiments, the modification option of step 418 may be offered to the first party in step 422.

At step 424, the funding system sends a plurality of invitations to the first party's invitees, that is, potential parties invited to participate in the organized funding circle. In embodiments, the invitations may be sent by a variety of methods (e.g. email, SMS, MMS, etc.). Further, the invitations may be sent to more potential parties than there are P parties. For example, a first party may trigger invitations sent to twenty potential parties when only a circle of 5 parties has been organized. Allowing the first party to send more invitations provides an advantage of a higher success rate of acceptance. The method 400 ends at step 426.

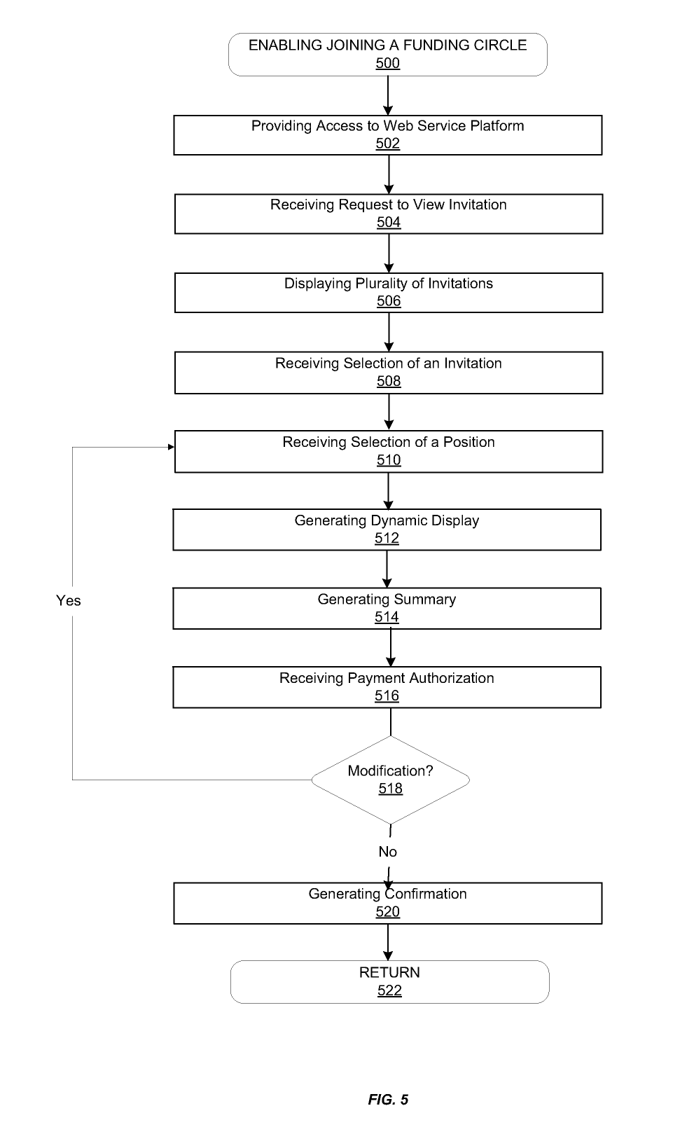

FIG. 5 is a flow diagram illustrating a method 500 for enabling a party to join an organized funding circle by accepting an invitation in accordance with an embodiment of the present invention. In embodiments, the plurality of parties, who have received the invitation to join the organized funding circle, may view and/or accept the invitation by accessing the web service platform. At step 502, the steps of method 300 of FIG. 3 are repeated to grant the party access to the web service platform.

At step 504, the party's request to view an invitation is received. At step 506, the invitation module, executing on the funding system, enables viewing of the invitation by generating a user interface (e.g., graphical user interface (GUI) displaying information about a plurality of invitations existing for that particular party. In one example, the party may have three invitations to join three different funding circles organized by different individuals belonging to the party's one or more social networks. In such example, the invitation module generates a display of three invitations for the party.

At step 508, the party's selection of a particular invitation is received, and the party may proceed to join the funding circle associated with the invitation by selecting a position in the funding circle. For example, when the funding circle has been organized for five participating parties, the party has four positions to choose from, as one of the positions is already taken by the first party who has organized the funding circle. At step 510, the party's selection of a position in the funding circle is received.

At step 512, a dynamic display containing a set of fractional parameters is generated in response to the party's selection. The content of the dynamic display changes according to the position selected by the party to reflect the corresponding fractional parameters computed for that particular position. The fractional parameters computed for each particular position assists the party in making an informed decision that corresponds to the party's financial needs. For example, the party is able to see that selecting a higher position will result in receiving the fund amount sooner while a lower position will yield a higher return on investment but with a longer waiting period.

At step 514, a summary of the funding circle and the party's selected position is generated for review. At step 516, subsequent to reviewing the summary, the party is prompted to finalize acceptance of the invitation by connecting to at least one payment processing service. Such connection, involving the authentication of login credentials (or e-wallet setup) and authorization of pre-approved transactions, allows the web service platform to facilitate financial transactions of the funding circle smoothly between the first party and the party who is joining. Once authentication and authorization are completed, the financial transactions can be made seamlessly every rotating cycle on behalf of the party, without any manual processing or interruption. It is noted that authentication and authorization of the at least one payment processing service discussed in step 420 of FIG. 4 is applicable here to the party joining the funding circle. At the end of step 516, authorization is received from the payment processing service via the payment interface.

At step 518, the funding system enables the party with a modification option. At this step, the funding system determines whether the party requests to modify information associated with the funding circle. The information may include, for example, the position selected in step 510. If the funding system determines that the party requests to change the position selected, for example, the system redirects the party to the GUI page to reselect the position. Subsequent to selecting a new position, steps 512-518 are repeated. Once the funding system determines that no modification is requested (e.g., “No”), the method continues at step 520. At step 520, a confirmation message is generated. The confirmation message includes information informing the party that a successful acceptance of the invitation to join has occurred and a summary of details associated with the funding circle in the invitation.

In embodiments, the process illustrated in FIG. 5 is repeated for the plurality of P parties of an organized funding circle. For example, for an organized funding circle of five parties, the process is repeated four times, such that a total number of four parties are able to successfully join the funding circle. Once all invited parties have accepted the invitation to join the organized funding circle, the funding circle becomes an active funding circle. The funding system deals with inactive funding circles (i.e., organized funding circles where not all invited parties have accepted the invitation to join) in different ways. For example, an inactive funding circle exists when a first party invites ten potential parties to join a five-party funding circle, but only one of the ten potential parties accepts the invitation. In some instances, the funding system, via the web service platform, automatically cancels and deletes the organized funding circle because of the insufficient number of accepted invitations. Such automatic cancellation and deletion may be based on, for example, a time-based algorithm, where an organized funding circle exceeding one month old gets deleted. In other instances, the funding system, via the web service platform, presents to the first party various options of how to proceed. These options may include, for example, inviting additional potential parties to join or cancelling and deleting the organized funding circle.

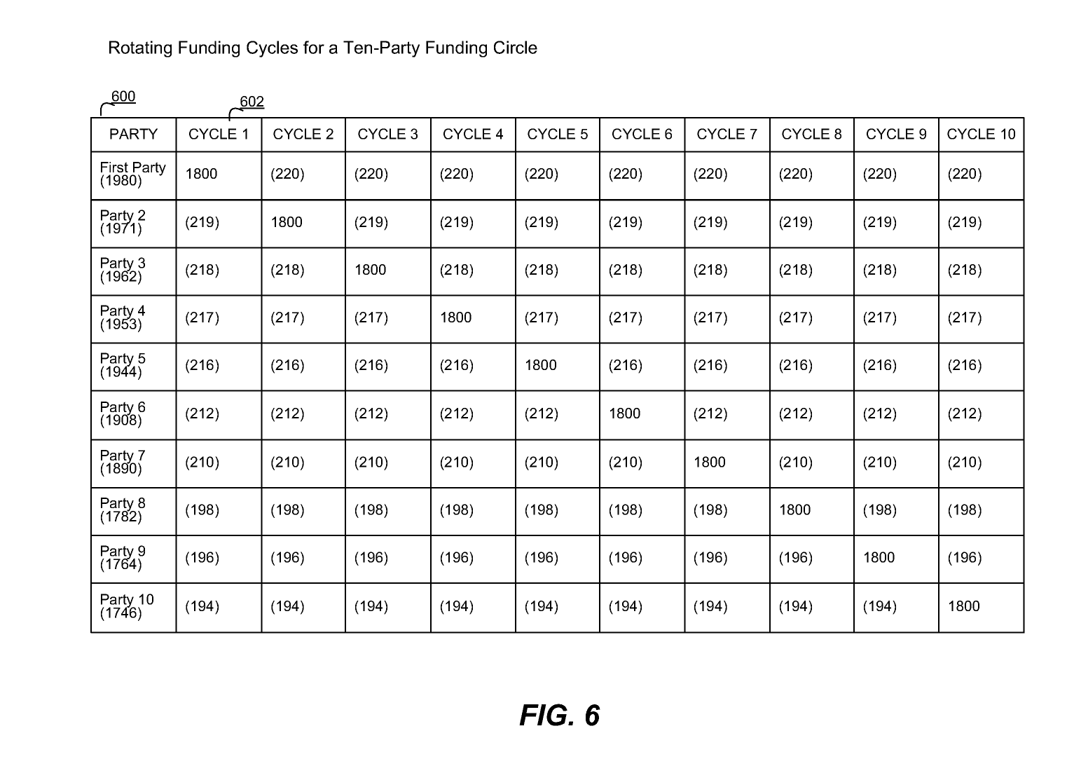

FIG. 6 provides an example illustrating ten rotating funding cycles 602 containing the fractional parameters (and associated values) computed for ten parties 600 of a funding circle, according to an embodiment of the present invention. While not all of the fractional parameters are shown in FIG. 6, the ones presented include the total contribution amount, the fixed fractional contribution amount, and the fund amount. In the example illustrated, a numerical value enclosed within parentheses signifies a negative amount (i.e., the amount being contributed out-of-pocket by a particular party). On the other hand, a numerical value without parentheses signifies a positive amount (i.e., the amount being received by a particular party). As illustrated in FIG. 6, for a ten-party funding circle, each participating party makes nine contributions for a total of nine rotating cycles. In each of the rotating cycle, the fixed fractional contribution amount varies for each party depending on the position held by that party. For example, the party holding the lowest position (“Party 10”) has a fixed fractional contribution amount of $194, which must be made in each of the nine rotating cycles, for a total contribution amount of $1746. Party 10 receives a fund amount of $1800 on the very last cycle, “Cycle 10.” In contrast, the party holding the highest position (“Party 1”) has a higher fixed fractional contribution amount of $220. Party 1 pays a higher total contribution amount of $1980, but receives the fund amount of $1800 on the very first cycle, “Cycle 1.”

The savings plan advantage is exemplified through Party 10. By taking a longer waiting period, letting nine rotating cycles to pass by before receiving the fund amount of $1800, Party 10 is compensated by the lowest fixed fractional contribution amount. Additionally, Party 10 receives a net gain of $54 (i.e., an excess gain difference between the fund amount and the total contribution amount), which signifies a 7% profit for contributing $1800 to the funding circle. In this example, Party 10, having extra small bits savings (e.g., $194 to spare every cycle) chooses to participate by taking the highest position, the most profitable position, in order to receive a profitable 7% return on investment. In exchange, Party 10 helps the friend Party 1 who needs the $1800 right away. As for Party 1, instead of a high interest rate loan, only a 10% cost is incurred by participating in the funding circle.

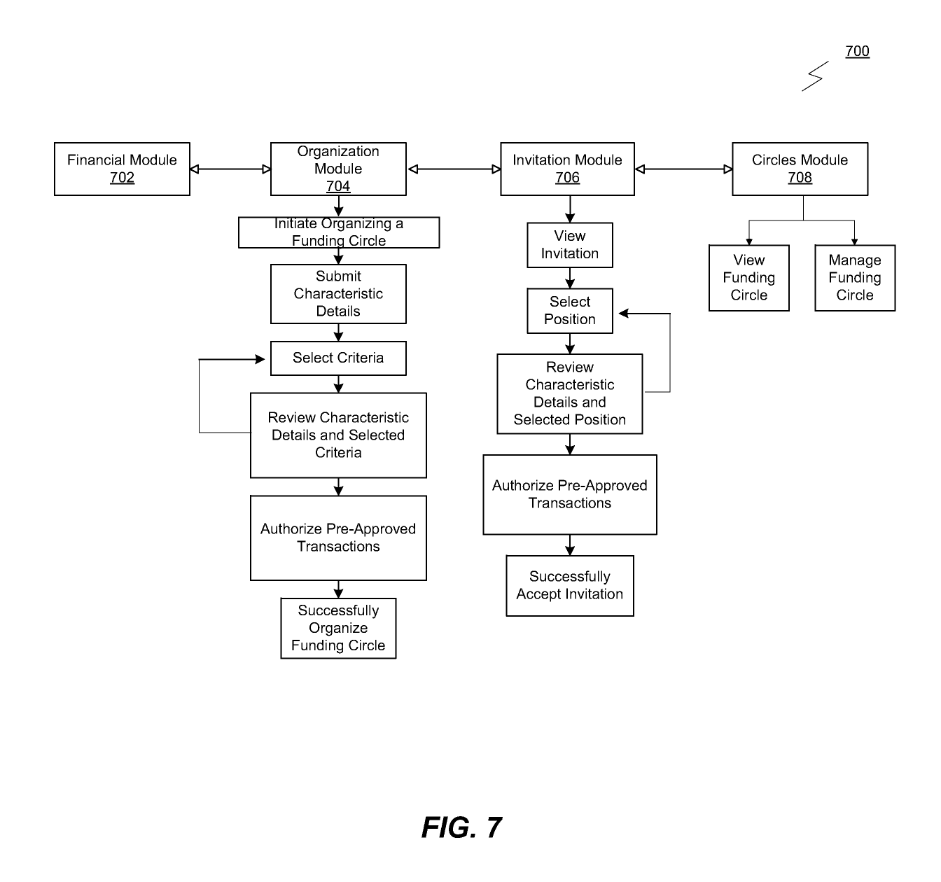

FIG. 7 is a block diagram illustrating the functionalities offered by the funding system via the web service platform in accordance with an embodiment of the present invention. In embodiments, a user of the funding system (e.g., a first party or a plurality of P parties), who has been granted access to the web service platform, is presented with a plurality of options that include, but is not limited to: organize a funding circle, view an invitation (i.e., an invitation to participate in a funding circle organized by another party), view an active funding circle in which the user is an active participant (i.e., an active funding circle organized either by the first party or by another party), view an organized funding circle (i.e., a circle not yet activated), and/or manage a funding circle. The plurality of options are supported by various modules executed on the web service platform. Referring to the illustration in FIG. 7, an organization module 704 enables the user to organize a plurality of funding circles on the web service platform. The circles module 708 enables the user to view, monitor, and/or manage the plurality of funding circles organized by the user. The funding circles may be not yet active, organized funding circles and active funding circles. The invitation module 706 enables the user to view and accept invitations to a plurality of funding circles, in addition to enabling the user to monitor the active funding circles in which the user is participating. The financial module 702 is used by the funding system to store, process, and compute all financial variables associated with a funding circle. The financial variables include, but are not limited to, corresponding terms of the funding circle, a fund receiving amount, a cycle contribution amount, a platform fee, and a fixed fractional contribution. In embodiments, the financial module 702 provides the supporting data for the organization module 704, the invitation module 706, and the circles module 708.

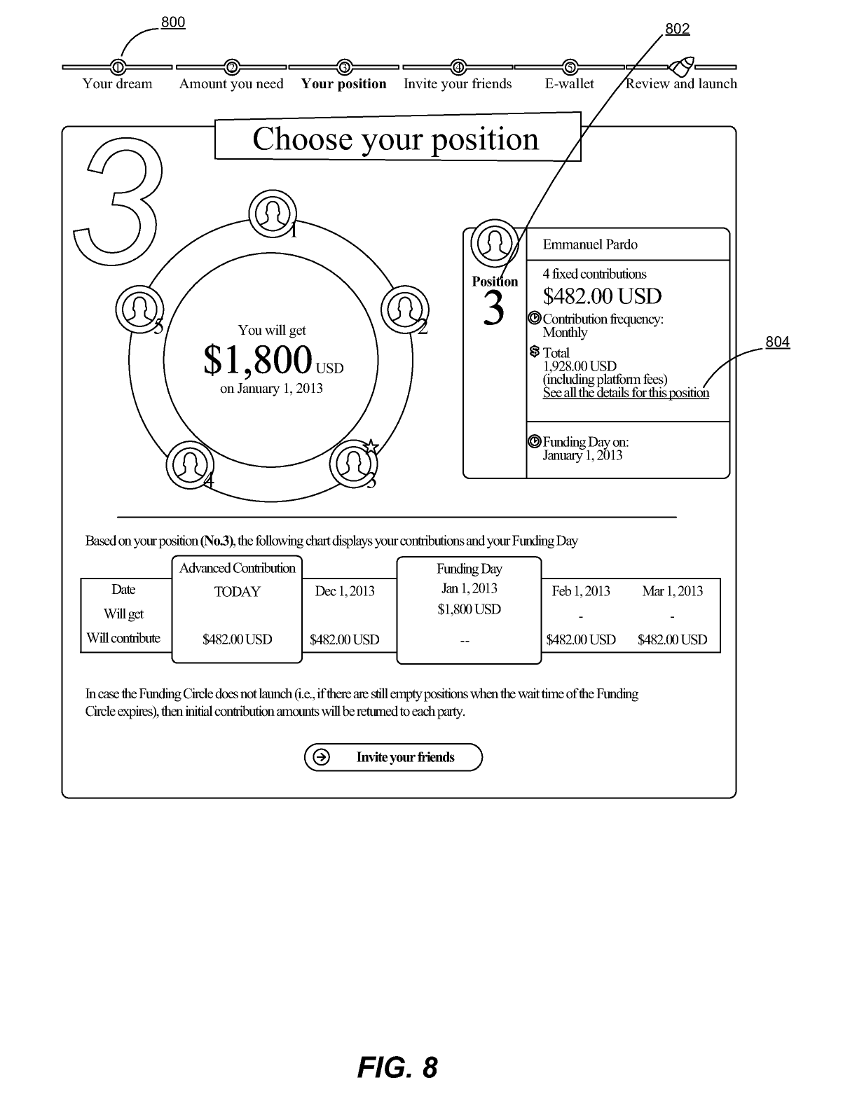

FIG. 8 is an example illustrating a dynamic display generated according to a position selected by a party. In the example, a position “3” has been selected. The dynamic display 800 generates the fractional parameters that correspond to the position selection 802. The values for the fractional parameters are computed by the financial module. The position details link 804, included in the fractional parameters, contains detailed information associated with the position selection 802. The details link provides transparency in the financial transactions occurring via the web service platform, allowing the user to see the detailed computations involved in funding circle.

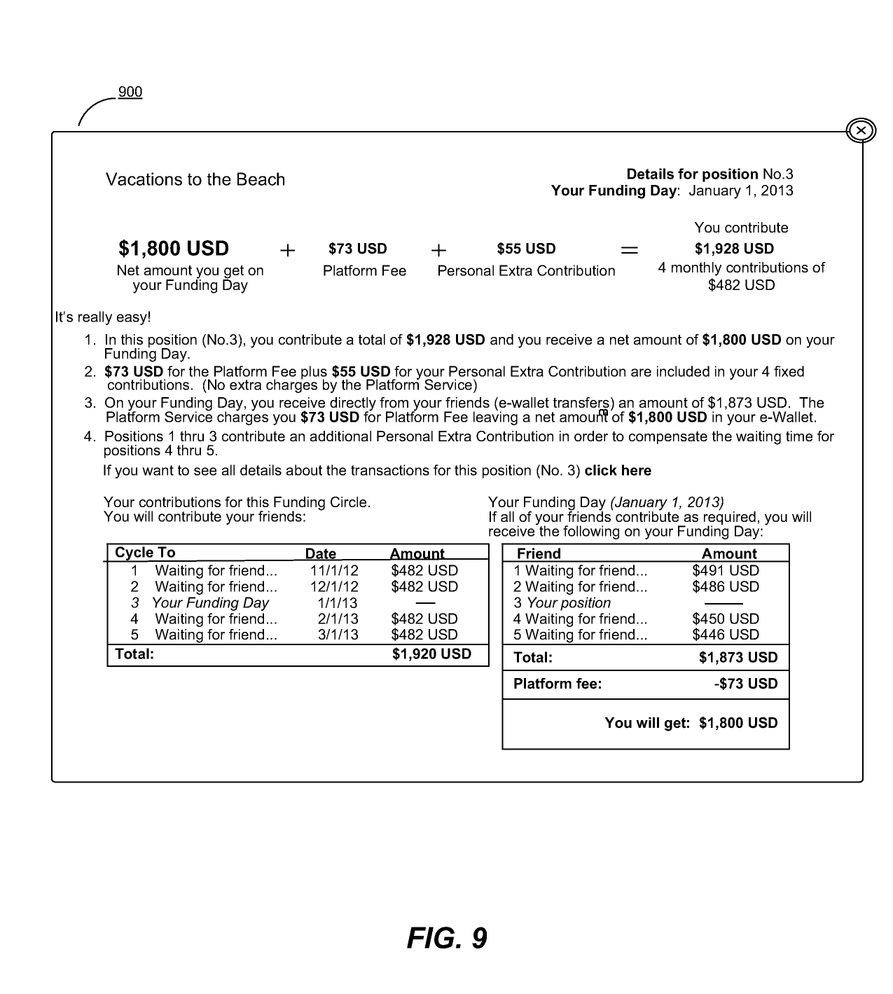

FIG. 9 is an example illustrating the detailed information contained in the position details link generated according to a position selected by a party.

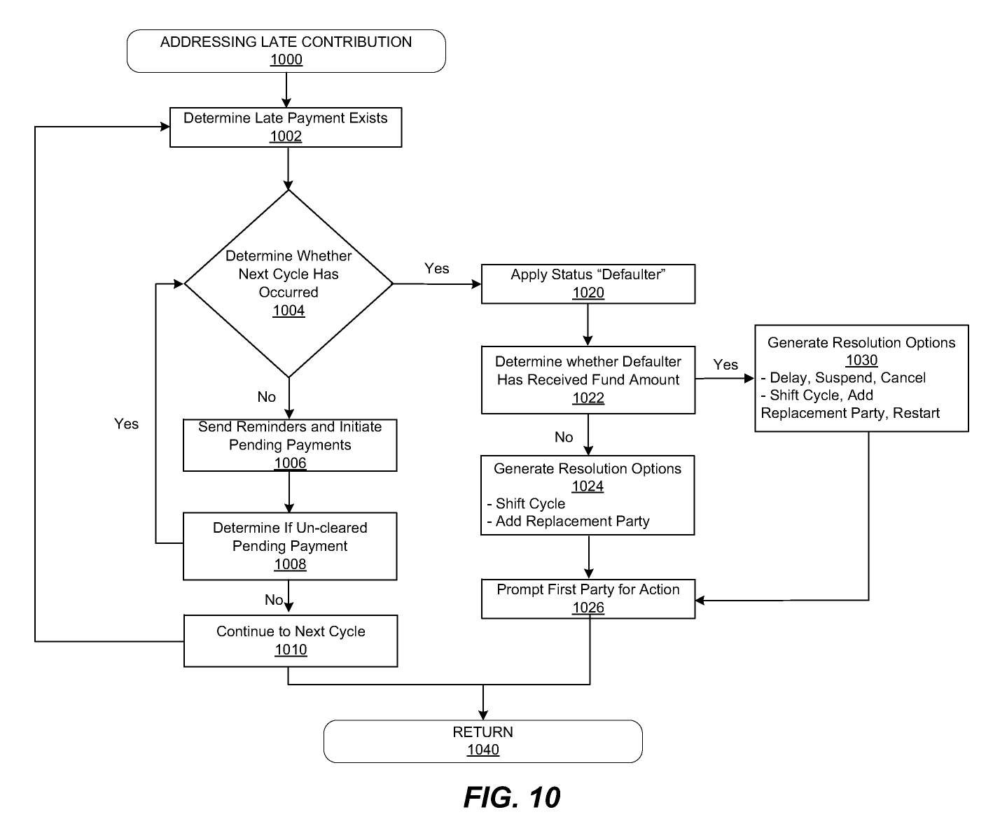

FIG. 10 is a flow diagram illustrating a method 1000 for addressing a late contribution payment according to an embodiment of the present invention. As will be discussed in further detail below, various risk management tools are provided in the present invention to assist a funding circle organizer (i.e., a first party) in addressing late contribution payments. A participating party may be a late party, for example, if the party's contribution payment has not been timely received according to the schedule of the rotating cycle. The late payment may be caused by a variety of reasons.

In embodiments, the late party is categorized into either a “late contributor” or a “defaulter” depending on the reason behind the late payment. The term “late contributor” as defined herein refers to a party who is willing and/or can continue to contribute, pending resolution of some personal issues that may have caused the late payment. The term “defaulter” as defined herein refers to a participating party who will not and/or cannot continue any longer to make contributions to the funding circle. For example, a defaulter is a party who requests the payment processing service to discontinue all pre-approved transactions associated with the funding circle and/or the web service platform. In such instances, the defaulter is unwilling to continue making contributions to the funding circle. In another example, a late contributor, whose payment processing service is via a VISA® credit card, is one who forgets to update the credit card on file with the payment processor e-Wallet, but is willing and can update the information once the issue is realized.

Various embodiments of the present invention address the default risk associated with the late party by providing the organizer a set of tools to communicate, inform, and make decisions on how to proceed with regards to the funding circle. In some embodiments, a system and method for generating a “Circle score” is provided. A party's past and/or present participation in a funding circle is tracked for timely contribution payment activities as well as late payment activities. A Circle score is computed according to the tracked record, and every time a party participates in a new funding circle, makes the fixed fractional contribution payments on time, the score is increased. The Circle score is attached to the party's profile on the web service platform. As a result, the Circle score applies an inherent social pressure on participating parties of the funding circle to diminish default risk. For example, a party is encouraged to make timely payments in order to have an attractive Circle score. In such instances, the attractive score enhances the party's social standing, allowing the party to be viewed as a reliable peer within the community. In some instances, the party becomes an attractive potential party to invite to a new funding circle, where the attractive Circle score enhances the party's trustworthiness and reduces any perceived risk associated with the party. In other instances, the party becomes an attractive first party, where more parties are willing to accept the invitation to join the party's organized funding circle because of the party's trustworthiness and low risk. The party may utilize the Circle score to search for other high scoring peers within the party's social networks on the web service platform. Additionally, the party may utilize the Circle score to search for peers outside of the party's social networks on the web service platform.

In some embodiments, a system and method for enabling transparency on the web service platform is provided. In one embodiment, the funding system monitors and provides progress information about the financial transactions associated with the funding circle on the web service platform. The progress information includes alerts about any late party for all participants to view on the web service platform. The resulting transparency applies a social shame that places pressure on the late party to pay the fixed fractional contribution amount. In another embodiment, the funding system sends a plurality of persistent reminders to the social network community associated with the late party. The participating parties in that social network community are able to see who is the late party in the funding circle. The resulting transparency within the community applies social pressure on the late party, in addition to creating opportunities for communication between the late party and the remaining parties to promote understanding as to the reason behind the late payment.

In another embodiment, the funding system triggers personal reminder messages to be sent to the late party, in addition to triggering a widespread community message. The messages may be sent directly to the part by a variety of methods (e.g. email, SMS, Facebook® Inbox message, etc.). All late parties are initially deemed late contributors. For a late contributor, the funding system initiates a plurality of persistent reminders about the late payment by using a variety of methods. In some instances, a personal message is sent directly to the late contributor (e.g. email, SMS, Facebook® Inbox message, etc.). In other instances, social pressure gets applied by having a widespread message sent to the social network community associated with the participating parties of the funding circle. For example, in a five-party funding circle made up of five parties socially connected via Facebook®, a reminder is posted on the Facebook® wall of the Event page for the funding circle, notifying all of the parties involved who is late in payment. As a result, the reminder posting operates as both a social pressure mechanism and a communication tool for promoting understanding by encouraging conversations with the late party who may be facing some personal challenges.

In some embodiments, a system and method for generating a set of resolution options available to the organizer for dealing with defaulters is provided. The late contributor becomes a defaulter upon occurrence of particular events. In one embodiment, a method utilizing a “heat-mapping” algorithm is provided. The heat-mapping algorithm determines the event occurrences at which to consider a late contributor as a defaulter. Initially, upon determination that a late payment has occurred for a particular rotating cycle, the heat-mapping algorithm is activated. In such instances, a determination of whether the next rotating cycle has occurred is made. For example, in a five-party funding circle set with a “monthly” frequency for payments, the late party, whose payment has not been received on the first day of a particular cycle, has 29 more days to address any personal issue that caused the late payment. As such, the next rotating cycle does not occur for another 29 days.

Upon a determination that the next cycle has not occurred, the late party maintains the status as a late contributor. For the late contributor, the funding system persistently sends out reminders regarding the fixed fractional contribution payments. In some instances, the reminders may be personal messages sent directly to the late party. In other instances, the reminders may be widespread messages sent to the social network community. In addition to the sending of reminders, the funding system sends instructions to the associated payment processing service to initiate the pending financial transaction (i.e., fixed fractional contribution amount) repeatedly until the pending financial transaction is cleared (i.e., successfully processed). In such instances, the time in between each repeated initiation of the pending transaction is configurable. For example, an initiation of the pending transaction may be set to repeat every 24 hours, every 5 days, etc., where the electronic payment service attempts to process the requested financial transaction according to the set time.

Upon a determination that the next cycle has occurred, the late party's status changes from a late contributor to a defaulter. The funding system evaluates the defaulter according to the heat-mapping algorithm. Under the heat-mapping algorithm, if the defaulter has not yet received the fund amount (i.e., not yet a receiving party according to the schedule of the rotating cycles), two resolution options are generated. First, an “add replacement party” resolution option is generated for the first party (i.e., organizer). In such instances, the first party is required to confirm with the defaulter that he/she is unwilling and/or unable to continue contributing to the funding circle. Upon such confirmation, the first party may proceed to find a replacement party for the position relinquished by the defaulter. Second, a “shift cycle” resolution option is generated for the first party to shift the funding circle to the left by one cycle. In such instances, the rotating cycles of the funding circle are reduced by one less cycle. As a result, the remaining parties who have not yet received the fund amount will receive a reduced fund amount (i.e., reduced by one less fixed fractional contribution amount). As for the parties who have already received the fund amount, a benefit results because each of these parties retains the whole amount for the fund received while having to pay a lesser total contribution amount, as such amount will be reduced by one less fixed fractional contribution amount (i.e., one less cycle to contribute).

In the event that the defaulter has received the fund amount, two categories of resolution options are generated under the heat mapping algorithm. In the first category, the first party may choose to wait by one of several resolution options: delay the transactions by one rotating cycle; suspend the rotating cycle schedule; or cancel the funding circle. In the second category, the first party may choose to proceed by one of several resolution options: shift cycle; add replacement party; or restart. In some embodiments, additional social pressure mechanisms are imposed on the defaulter who has already received the fund amount. In some instances, the defaulter may be banned from utilizing the web service platform. In other instances, automated messages regarding the defaulting status are posted on the defaulter's public community forum and on the defaulter's funding circle specific forum. For example, upon a default, a message about the default gets posted on the defaulter's Facebook® wall in addition to the wall of the Facebook® funding circle Event page.

Referring to step 1002 of FIG. 10, a late contribution payment for a particular rotating cycle of a funding circle has been determined to exist. At step 1004, the funding system determines whether the next rotating cycle has yet occurred. Upon a determination that time still remains until the next rotating cycle (i.e., “No” determination), the funding system sends out reminders regarding the late payment at step 1006. The reminders may be personal reminders sent directly to the late party (late contributor) or reminders sent to the social network community to which the late party belongs. Additionally, pending payment is initiated with the associated third party payment processing service. At step 1008, the funding system determines whether the initiated pending payment is still not cleared or processed by the payment processing service. Upon a “No” determination, the funding system continues facilitating the funding circle according to the next scheduled rotating cycle, as indicated in step 1010. Upon a “Yes” determination (i.e., the contribution payment is still pending), the funding system repeats the process by starting with the determination of whether the next rotating cycle has occurred, as indicated in step 1004.

At step 1020, the funding system has decided that the next rotating cycle is due to occur or has already occurred at the time of the late contribution payment (or un-cleared pending payment). The late party's status changes from “late contributor” to “defaulter” in step 1020. At step 1022, the funding system proceeds to determine whether the defaulter has yet received the rotating fund amount of the funding circle. Upon a “No” determination, several resolution options are generated for the first party to take action, as indicated in step 1024. At step 1026, the first party is prompted by funding system via the web service platform to proceed with one of the generated options. Upon a “Yes” determination that the defaulter has not received the rotating fund amount, several other resolution options are generated for the first party to take action, as indicated in step 1030. The first party is again prompted by funding system via the web service platform, as indicated in step 1026, to proceed with one of the options generated. The method 1000 ends at step 1040.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method comprising:
providing a web service platform integrated with a networking interface and a payment interface;
enabling a first party to organize a funding circle executing on the web service platform, the funding circle including a plurality of financial transactions conducted between the first party and a plurality of parties connected within a social network associated with the first party, the plurality of parties invited by the first party to the funding circle via the networking interface;
enabling the plurality of parties to join the funding circle, the plurality of parties and the first party forming a set of parties, wherein the enabling includes:
for each of the set of parties,
enabling the party to select a distinct position in the funding circle; and
determining a fixed fractional contribution amount associated with a fund receiving date based on the distinct position; and
executing the plurality of financial transactions associated with the funding circle for the set of parties in a sequence based on a plurality of distinct positions associated with the funding circle, wherein each party of the set of parties sequentially receives the fund amount on the fund receiving date associated with the party, wherein the executing includes:
for each of the plurality of financial transactions, causing a specified party of the set of parties to receive the fund amount, the fund amount including a set of fixed fractional contribution amounts contributed by remaining parties of the set of parties, wherein each of the set of fixed fractional contribution amounts of the remaining parties is less than the fixed fractional contribution amount of the specified party in a subsequent financial transaction of the plurality of financial transactions.

2. The method of claim 1, further comprising:
receiving from the first party a selection of a plurality of criteria for organizing the funding circle;
determining a set of fractional parameters corresponding to the plurality of criteria selected by the first party;
computing a set of values associated with the set of fractional parameters; and
executing the plurality of financial transactions based on the computed set of values.

3. The method of claim 1, wherein enabling the first party to organize the funding circle comprises:
providing, to the first party, access to the web service platform via the networking interface;
enabling the first party to invite, from a plurality of social networks connected via the networking interface, a plurality of potential parties to join the funding circle;
enabling the first party to select a plurality of criteria for organizing the funding circle, the plurality of criteria including a home location, a frequency, a number of parties, the fund amount, and the distinct position corresponding to the of parties;
generating a dynamic display in response to the plurality of criteria selected by the first party, the dynamic display containing specific information associated with the plurality of criteria;
enabling the first party to authorize pre-approved financial transactions associated with the funding circle via the payment interface; and
generating a confirmation associated with a successful organization of the funding circle, wherein the successful organization triggers a transmission of a plurality of invitations associated with the funding circle.

4. The method of claim 3, further comprising:
receiving from the first party characteristic details about the funding circle, the characteristic details including a name, a description, and a content item.

5. The method of claim 3, further comprising:
determining for each of the plurality of P parties selected an individual set of fractional parameters, the individual set of fractional parameters including:
terms;
the fund receiving date;
the fund amount;
a contribution date; and
the fixed fractional contribution amount, wherein the fixed fractional contribution amount is computed based on the distinct position selected by the first party.

6. The method of claim 3, wherein generating a dynamic display comprises enabling the first party to modify the distinct position and to modify characteristic details about the funding circle.

7. The method of claim 1, wherein enabling the plurality of parties to join the funding circle further comprises:
providing, to each of the plurality of parties, access to the web service platform via the networking interface;
enabling each party to view an invitation for participating in the funding circle, wherein each party is able to accept the invitation by selecting one of the plurality of distinct positions associated with the funding circle;
enabling each party to authorize pre-approved financial transactions associated with the funding circle via the payment interface; and
generating a confirmation associated with an acceptance of the invitation, wherein the acceptance triggers a notification sent to the first party.

8. The method of claim 7, wherein enabling each party to view an invitation further comprises:
generating a dynamic display in response to the position selected by each party, wherein content of the dynamic display changes corresponding to the distinct position selected.

9. The method of claim 8, wherein the content of the dynamic display comprises a set of fractional parameters, the set of fractional parameters including:
terms, the terms containing a total quantity of contribution payments, total contribution amount, a platform fee, an extra contribution amount, a first cycle contribution date, and a position details link associated with the position selected;
the fund receiving date;
the fund amount;
a contribution date; and
the fixed fractional contribution amount.

10. The method of claim 1, further comprising generating an invitation user interface for viewing and accepting a plurality of invitations associated with a plurality of organized funding circles.

11. The method of claim 1, further comprising generating a user interface for viewing and managing a plurality of organized funding circles and a plurality of active funding circles.

12. A system comprising:
means for providing a web service platform integrated with a networking interface and a payment interface;
means for a first party to organize a funding circle executing on the web service platform, the funding circle including a plurality of financial transactions conducted between the first party and a plurality of parties connected within a social network associated with the first party, the plurality of parties invited by the first party to the funding circle via the networking interface;
means for enabling the plurality of parties to join the funding circle, the plurality of parties and the first party forming a set of parties, wherein the enabling includes:
for each of the set of parties,
enabling the party to select a distinct position in the funding circle; and
determining a fixed fractional contribution amount associated with a fund receiving date based on the distinct position; and
means for executing the plurality of financial transactions associated with the funding circle for the set of parties in a sequence based on a plurality of distinct positions associated with the funding circle, wherein each party of the set of parties sequentially receives the fund amount on the fund receiving date associated with the party, wherein the executing includes:
for each of the plurality of financial transactions, causing a specified party of the set of parties to receive the fund amount, the fund amount including a set of fixed fractional contribution amounts contributed by remaining parties of the set of parties, wherein each of the set of fixed fractional contribution amounts of the remaining parties is less than the fixed fractional contribution amount of the specified party in a subsequent financial transaction of the plurality of financial transactions.

13. The system of claim 12, further comprising:
means for receiving from the first party a selection of a plurality of criteria for organizing the funding circle;
means for determining a set of fractional parameters corresponding to the plurality of criteria selected by the first party;
means for computing a set of values associated with the set of fractional parameters; and
means for executing the plurality of financial transactions based on the computed set of values.

14. The system of claim 12, further comprising means for generating an invitation user interface for viewing and accepting a plurality of invitations associated with a plurality of organized funding circles.

15. The method of claim 12, further comprising means for generating an a circles user interface for viewing and managing a plurality of organized funding circles and a plurality of active funding circles.

16. A method for organizing a funding circle of a funding system, the method comprising:
receiving authentication credentials via a networking interface integrated with a web service platform executing on a funding system, wherein the first party gains access to the web service platform by authorizing data exchange between the funding system and a social network associated with the first party;
enabling the first party to organize a funding circle on the web service platform according to a selection of a plurality of criteria, the funding circle including a plurality of financial transactions conducted between the first party and a plurality of parties, the first party and the plurality of parties forming a set of parties participating in the plurality of financial transactions;
determining a set of fractional parameters associated with a position among the set of parties, wherein each of the set parties sequentially receives a fund amount on a fund receiving date associated with the party based on the position and the set of fractional parameters, the fund amount including a set of fixed fractional contribution amounts contributed by remaining parties of the set of parties, each of the set of fixed fractional contribution amounts being less than a respective fixed fractional contribution amount of the party in a subsequent financial transaction of the plurality of financial transactions;
receiving authorization from a payment processing service associated with the first party via a payment interface for pre-approval of financial transactions associated with the funding circle;
generating a confirmation associated with a successful organization of the funding circle, wherein the successful organization triggers a transmission of a plurality of invitations associated with the funding circle.

17. The method of claim 16, further comprising:
generating a dynamic display containing the set of fractional parameters, wherein content of the dynamic display changes according to a given position selected by the first party during organization of the funding circle.

18. The method of claim 16, wherein the plurality of criteria comprises:
a home location, a frequency, a number of parties, the fund amount, and the position among the plurality of parties.

19. The method of claim 16, wherein the plurality of parties is populated by inviting participants from the social network associated with the first party.

20. The method of claim 19, wherein a number of participants being invited is more than the number of the plurality of parties selected for the funding circle.
